(19) United States
(12) Patent Application Publication
(10) Pub. No.: US 2026/0121944 A1
(43) Pub. Date: Apr. 30, 2026

(54) CROSS-DOMAIN APPROACH TO OPTIMIZE WIRELESS FIDELITY (WIFI) DEVICE ROAMING IN A FABRIC-BASED NETWORK

(71) Applicant: Cisco Technology, Inc., San Jose, CA (US)

(72) Inventors: Eric Levy-Abegnoli, Valbonne (FR); Pascal Thubert, Roquefort-les-Pins (FR); Jean-Philippe Vasseur, Issy Les Moulineaux (FR); Patrick Wetterwald, Mouans Sartoux (FR); Jerome Henry, Pittsboro, NC (US)

(73) Assignee: Cisco Technology, Inc., San Jose, CA (US)

(21) Appl. No.: 18/926,553

(22) Filed: Oct. 25, 2024

(51) Int. Cl. H04L 41/40

(52) U.S. Cl. CPC H04L 41/40

(57) ABSTRACT

A cross-domain approach to optimize Wireless Fidelity (WiFi) device roaming in a fabric-based network may be provided. A first Access Point (AP) may determine a current location of a first user device connected to the first AP of a fabric-based network. The first AP may be attached to a first Fabric Edge (FE). The first AP may receive an indication of movement of the first user device from the current location. The first AP may predict a next AP where the first user device is most likely to roam to from the first AP based on the current location and a trajectory of the movement from the current location. The next AP may be attached to a second FE of the fabric-based network. The first AP may trigger pre-provisioning of resources at the second FE to create a secondary route for the first user device through the second FE.

### TECHNICAL FIELD

The present disclosure relates generally to a cross-domain approach to optimize Wireless Fidelity (WiFi) device roaming in a fabric-based network.

### BACKGROUND

In computer networking, a wireless Access Point (AP) is a networking hardware device that allows a Wireless Fidelity (WiFi) compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (LAN) Controller (WLC). An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment for a cross-domain approach to optimize Wireless Fidelity (WiFi) device roaming in a fabric-based network;

FIG. 2 illustrates an example enterprise fabric overlay with Virtual extensible Local Area Network (VxLAN) tunnels;

FIG. 3 illustrates a roaming process for a user device in an enterprise fabric overlay;

FIG. 4 is a flow chart of a method for a cross-domain approach to optimize WiFi device roaming in a fabric-based network;

FIG. 5 illustrates a prediction based roaming process for a user device in a fabric-based network; and

FIG. 6 is a block diagram of a computing device.

### DETAILED DESCRIPTION

### Overview

A cross-domain approach to optimize Wireless Fidelity (WiFi) device roaming in a fabric-based network may be provided. A first Access Point (AP) may determine a current location of a first user device. First AP may be attached to a first Fabric Edge (FE) of a fabric-based network and the first user device may be wirelessly connected to the first AP. The first AP may receive an indication of movement of the first user device from the current location. The first AP may predict a next AP where the first user device is most likely to roam to from the first AP based on the current location and a trajectory of the movement from the current location. The next AP may be attached to a second FE of the fabric-based network. The first AP may trigger pre-provisioning of resources at the second FE to create a secondary route for the first user device through the second FE in the fabric-based network.

Both the foregoing overview and the following example implementations are examples and explanatory only and should not be considered to restrict the disclosure's scope, as described and claimed. Furthermore, features and/or variations may be provided in addition to those described. For example, implementations of the disclosure may be directed to various feature combinations and sub-combinations described in the example implementations.

### Example Implementations

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Wireless Fidelity (WiFi) signal power may be limited by regulations limiting its reachability. WiFi signal reachability may further be affected by WiFi signal wavelength. For example, a longer wavelength may result in a shorter reachability. In addition, WiFi signal with a longer wavelength may not be able to penetrate solid objects further limiting its reachability. Similarly, higher frequency WiFi signals may attenuate more with travel distance. The attenuation may be more pronounced at higher frequencies because the higher frequency may lead to more absorbance by objects and increase in path losses. With WiFi 8 operating in these higher frequencies, multiple Access Points (APs) may be provided to improve the WiFi signal reachability. Increase in APs may lead to more frequent roaming for a user device seeking better reachability.

In a fabric-based network, for example, a campus network or an enterprise network, APs are wired to Fabric Edges (FEs) where data traffic may be switched. When a user device roams, a time for the fabric-based network to converge (that is, socialize a new location of the user device) may be noticeable or impactful. An application (for example, a voice, a data, a Virtual Reality (VR), etc.) that may be sensitive to traffic loss or traffic delay may notice the convergence time rendering an interaction between the user device and the fabric-based network poor irrespective of the efficiency of the fabric-based network. The disclosure, therefore, may provide a cross-domain approach to improve roaming of a user device in a fabric-based network. For example, the disclosure uses Machine Learning (ML) models to predict a next Point of Attachment (PoA) of a roaming device and may pre-provision the PoA for the roaming device before the roaming devices roams to the next PoA. Pre-provisioning may reduce the convergence time of the roaming device.

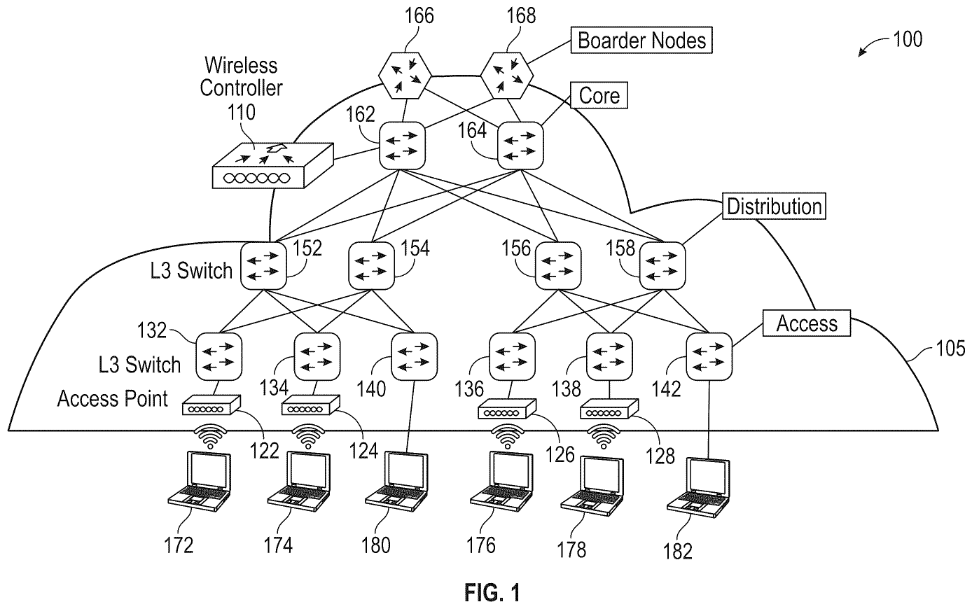

FIG. 1 illustrates an operating environment 100 for a cross-domain approach to optimize WiFi device roaming in a fabric-based network. As shown in FIG. 1, operating environment 100 may include a fabric-based network 105 and a controller 110. Controller 110 may be connected to or wired into fabric-based network 105. Controller 110 may comprise a Wireless Local Area Network controller (WLC) and may provision and control fabric-based network 105.

Fabric-based network 105 may include a plurality of APs, for example, a first AP 122, a second AP 124, a third AP 126, and a fourth AP 128. Each of the plurality of APs may be compatible with specification standards such as, but not limited to, the Institute of Electrical and Electronics Engineers (IEEE) 802.11 specification standard for example. Each of the plurality of APs may be connected to an access switch or a Layer 3 (L3) switch. As shown in FIG. 1, fabric-based network 105 may include a plurality of access switches, for example, a first access switch 132, a second access switch 134, a third access switch 136, a fourth access switch 138, a fifth access switch 140, and a sixth access switch 142. First AP 122 may be wired to first access switch 132, second AP 124 may be wired to second access switch 134, third AP 126 may be wired to third access switch 136, and fourth AP 128 may be wired to fourth access switch 138. In some examples, an access switch is also referred to as a FE.

Fabric-based network 105 may further include a plurality of distribution switches, for example, a first distribution switch 152, a second distribution switch 154, a third distribution switch 156, a fourth distribution switch 158. In addition, fabric-based network 105 may include a plurality of core switches, for example, a first core switch 162 and a second core switch 164 and a plurality of border nodes, for example, a first border node 166 and a second border node 168.

Each of the plurality of access switches may be connected to or wired to one or more distribution switches. For example, each of first access switch 132, second access switch 134, and third access switch 136 may be connected to both first distribution switch 152 and second distribution switch 154. Moreover, each of fourth access switch 138, fifth access switch 140, and sixth access switch 142 may be connected to both third distribution switch 156 and fourth distribution switch 158.

Each of the plurality of distribution switches may be connected to or wired to one or more core switches. For example, each of first distribution switch 152, second distribution, third distribution switch 156, and fourth distribution switch 158 may be connected to both first core switch 162 and second core switch 164. Each of plurality of core switches may in turn be connected to or wired to one or more border nodes. For example, each of first core switch 162 and second core switch 164 may be connected to each of first border node 166 and second border node 168. The plurality of border nodes may allow traffic to egress and ingress fabric-based network 105. The plurality of border nodes may also function as a connection point between fabric-based network 105 and outside networks.

Operating environment 100 may further include a plurality of user devices, for example, a first user device 172, a second user device 174, a third user device 176, a fourth user device 178, a fifth user device 180, a sixth user device 182. The plurality of user device may include limited to, a smart phone, a Head Mounted Device (HMD), a personal computer, a tablet device, a mobile device, a telephone, a remote control device, a set-top box, an Internet-of-Things (IoT) device, a network computer, a router, Augmented Reality (AR)/Virtual Reality (VR)/XR devices, or other similar microcomputer-based device.

Each of the plurality of user device may associate or wirelessly connect to one of the plurality of APs or access switches to connect to fabric-based network 105. For example, first user device 172 may associate with first AP 122, second user device 174 may associate with second AP 124, third user device 176 may associate with third AP 126, fourth user device 178 may associate with fourth AP 128, fifth user device 180 may associate with fifth access switch 130, and sixth user device 182 may associate with sixth access switch 142.

Controller 110 may include any device configured to track and update connectivity and mobility of the plurality of user devices in fabric-based network 105. AP image and configuration management, client session management, and mobility services may be provided by controller 110. Further, controller 110 may provide additional fabric integration services, such as registering user device Media Access Control (MAC) addresses in a host tracking database join events and providing association updates for roaming events.

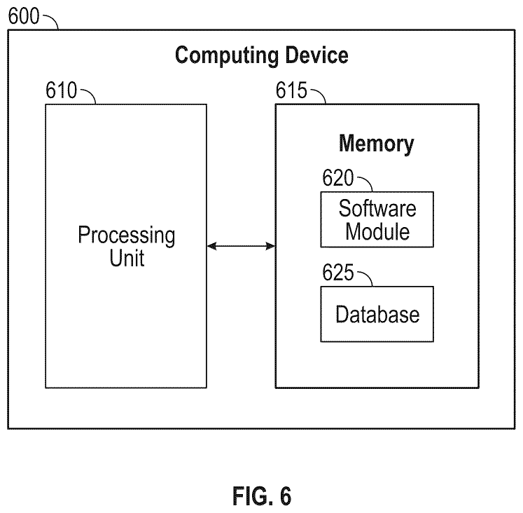

The elements described above of operating environment 100 (e.g., controller 110, first AP 122, second AP 124, third AP 126, fourth AP 128, first access switch 132, second access switch 134, third access switch 136, fourth access switch 138, fifth access switch 140, sixth access switch 142, first distribution switch 152, second distribution switch 154, third distribution switch 156, fourth distribution switch 158, first core switch 162, second core switch 164, first border node 166, and second border node 168) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 6, the elements of operating environment 100 may be practiced in a computing device 600.

In example implementations, the plurality of user devices may reach each other over a network overlay that may abstract an underlay topology of fabric-based network 105. Reachability within the network overlay may be established with Locator Identification (ID) Separation Protocol (LISP) in Software Define Access (SDA) network or with Border Gateway Protocol (BGP) in ethernet Virtual Private Network (eVPN) fabric. For example, APs of fabric-based network 105 may be considered as fabric extensions and may be configured to send encapsulated/tunneled traffic to a FE for the device data traffic. APs may use a Virtual extensible Local Area Network (VxLAN) tunnel in the SDA fabric. These frames may be processed at the FE node and sent into the fabric overlay. For the FE node to process these frames, it may need an access tunnel interface to the APs. To configure this, controller 110 may create, for each AP, a specific entry in a LISP control plane server to register the AP location and notify the corresponding FE node. In the case of the SDA fabric, controller 110 may leverage a Layer 2 (L2) Virtual Network ID (VNID) entry in the LISP Map Server (MS)/Map Resolver (MR) (MS/MR), using the AP radio MAC address as an Endpoint ID (EID). This entry may be used to trigger an access tunnel creation on a switch associated with the fabric edge.

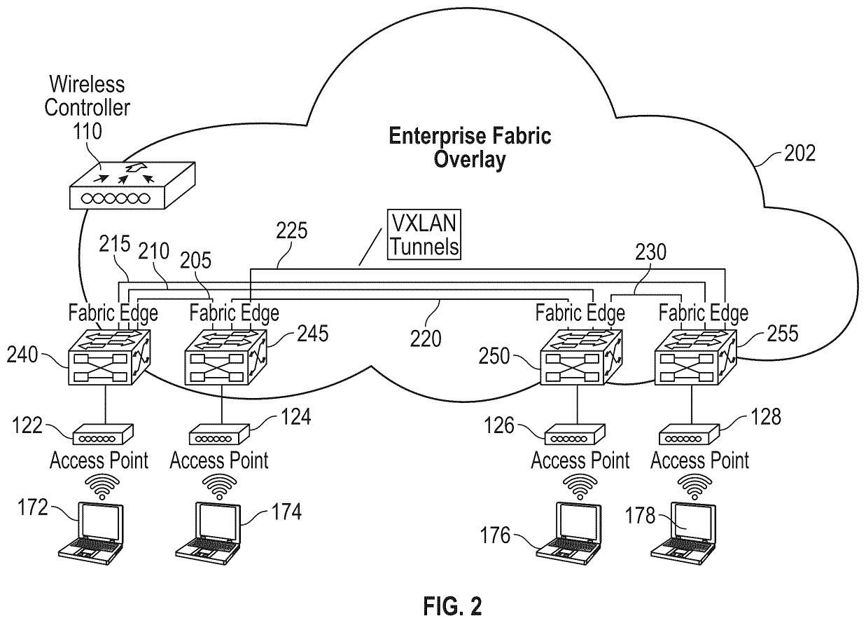

FIG. 2 illustrates an enterprise fabric overlay 202 with VxLAN tunnels of fabric-based network 105. As shown in FIG. 2, enterprise fabric overlay 202 may include a plurality of VxLAN tunnels, for example, a first VxLAN tunnel 205, a second VxLAN tunnel 210, a third VxLAN tunnel 215, a fourth VxLAN tunnel 220, a fifth VxLAN tunnel 225, and a sixth VxLAN tunnel 230. First VxLAN tunnel 205, for example, may be established between a first FE 240 and second FE 245. First VxLAN tunnel 205 may be used by first user device 172 that may be connected to first FE 240 through first AP 122 to reach to second user device 174 that may be connected to second FE 245 through second AP 124. For example, first AP 122 may send encapsulated/tunneled traffic originating from first user device 172 to first FE 240. These frames may be processed at first FE 240 and sent into enterprise fabric overlay 202 through first VxLAN tunnel 205. Second FE 245 may receive the frames on first VxLAN tunnel 205 and send the frames to second AP 124 which in turn may send them to second user device 174. First VxLAN tunnel 205 may also be used by second user device 174 to reach to first user device 172.

Similarly, second VxLAN tunnel 210 may be established between first FE 240 and third FE 250, third VxLAN tunnel 215 may be established between first FE 240 and fourth FE 255, fourth VxLAN tunnel 220 may be established between second FE 245 and third FE 250, fifth VxLAN tunnel 225 may be established between second FE 245 and fourth 255, and sixth VxLAN tunnel 230 may be established between third FE 250 and fourth FE 255.

Mobility of a user device (that is, user device roaming) may be defined as a user device changing its PoA in fabric-based network 105. In fabric-based network 105, the PoA of a user device may not be an AP that the user device may be associated with but an FE to which the AP may be wired to. This PoA, provided as a Resource Locator (RLOC) for an SDA fabric and a Virtual Tunnel End Point (VTEP) for an eVPN, may be distributed across fabric-based network 105 to enable communication between user devices or from a user device to a boarder node. The PoA may be distributed by using a push model for eVPN and a pull model for the SDA fabric. In addition, when the PoA of a given resource is received on a FE, a VxLAN tunnel to that resource may need to be programmed in an Application Specific Integrated Circuits (ASICs). Both the distribution of the resource PoA and the ASICs programming may be time consuming. Thus, when a user device moves or roams, a time needed for the user device to become reachable again (that is, a roaming time) may be significant (for example, between 1 ms-100 ms).

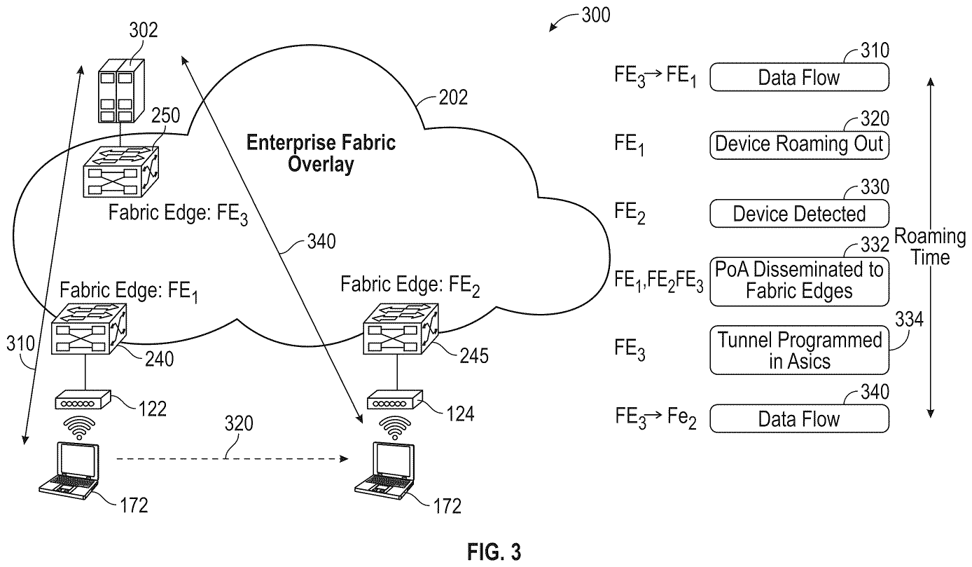

FIG. 3 illustrates example roaming process 300 of a user device in enterprise fabric overlay 202. As shown in FIG. 3, first user device 172 that is connected to first FE 240 through first AP 122 may be receiving/sending data from a first server 302 connected to third FE 250 (stage 310). First user device 172 may start to move or roam from a range of first AP 122 towards a range of second AP 124 (stage 320). First user device 172 may be detected in the range of second AP 124 (stage 330). Hence, a PoA of first user device 172 may potentially change from first FE 240 to second FE 245 as second AP is wired to second FE 245. The changed PoA for first user device 172 may be disseminated to other FEs of enterprise fabric overlay 202 (stage 332). A VxLAN tunnel may be programmed in the ASICs between second FE 245 and third FE 250 (stage 334) for first user device 172 to continue receiving/sending data to first server 302. Once, the VxLAN tunnel is programmed, data may flow between server 302 and first user device 172 using the VxLAN tunnel (stage 440). A roaming time may be the time spent between stage 310 and stage 340 of process 300.

As discussed above, with WiFi8, user devices may be expected to roam more frequently across APs in fabric-based network 105. Such roaming actions may be expensive and may impact a user experience. The disclosure provides processes to reduce the roaming time or a convergence time of a user device in fabric-based network 105. Processes disclosed herein may predict a next PoA of a user device in fabric-based network 105 and may pre-provision resources at the next PoA before the user device roams to the next PoA. This pre-provisioning of the resources may reduce the roaming time for the user device. The prediction may be performed by ML models that may predict or forecast a user device movement based on tracking a current location, a trajectory of movement from the current location, past trajectories of the user device, past trajectories of other user devices, etc. The ML models may also use location information of the plurality of APs to predict the next PoA. The prediction may be made self-fulfilling by forcing the user device to attach to a selected AP when WiFi signal parameters are better than a predetermined level and resources have been pre-provisioned for imminent roaming.

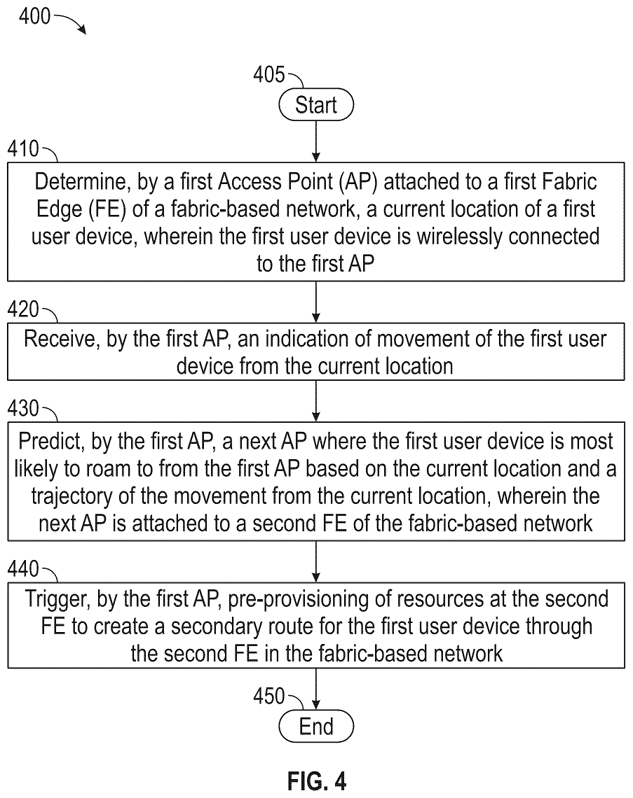

FIG. 4 is a flow chart setting forth the general stages involved in a method 400 consistent with an embodiment of the disclosure for a cross-domain approach to optimize WiFi device roaming in fabric-based network 105. Method 400 may be implemented at first AP 122 as described in more detail above with respect to FIG. 1. In some implementations, method 400 may be implemented at other elements of fabric-based network 105, for example, controller 110. Ways to implement the stages of method 400 will be described in greater detail below.

Method 400 may begin at starting block 405 and proceed to stage 410 where first AP 122 may determine a current location of first user device 172. First user device 172 may be wirelessly connected to first AP 122 that is wired to first FE 240 of fabric-based network 105. A current location of first user device 172 may be determined using a WiFi location tracking process. In one example, first user device 172 may be a personal computing device or a mobile device of a first student in a first classroom of a university.

Once having determined the current location of first user device 172 at stage 410, method 400 may proceed to stage 420 where first AP 122 may receive an indication of movement of first user device 172 from the current location. Movement of first user device 172 from the current location may be detected using the WiFi location tracking process. For example, first AP 122 may detect that the first student may be walking out of the first classroom based on updated current location of the mobile device of the first student.

After receiving the indication of movement from the current location at stage 420, method 400 may proceed to stage 430 where first AP 122 may predict a next AP where first user device 172 may be most likely to roam to from first AP 122 based on the current location and a trajectory of the movement from the current location. The next AP may be second AP 124 that is wired to or attached to second FE 245 of fabric-based network 105. As discussed in greater detail in the following sections of the disclosure, ML models may be used to predict the next AP. For example, first AP 122 may predict that the first student, based on the current location (that is, a hallway near the first classroom) and the trajectory of movement, may be walking towards a second classroom or a cafeteria. The second classroom or the cafeteria may be within a range of second AP 124 that may be wired to second FE 245.

Once having predicted the next AP where first user device 172 is most likely to roam to from first AP 122 at stage 430, method 400 may proceed to stage 440 where first AP 122 may trigger pre-provisioning of resources at second FE 245 with which the next AP may be attached to. For example, first AP 122 may trigger for a VxLAN tunnel to be set up or programmed from second FE 245 to be used by first user device 172. After triggering the pre-provisioning of resources at second FE 245 at stage 440, method 400 may end at stage 450.

A trajectory Projection Module (TPM) may be used to predict the next AP where first user device 172 is most likely to roam to from its current location. The TPM may have access to a location of each APs of fabric-based network 105. The TPM may use historical information about a roaming pattern of the plurality of user devices of fabric-based network 105, the location of each APs of fabric-based network 105, and the trajectory of movement of first user device 172 to predict the next AP where first user device 172 may be most likely to roam to in fabric-based network 105. For example, from the past data, the TPM may predict that the first student may be going to the cafeteria for lunch after a first lecture in the first classroom.

A first approach may include modeling the trajectory of first user device 172 and using a ML model to model AP selection performed by first user device 172 according to its location based on the trajectory and previously recorded metrics (such as the Received Signal Strength Indication (RSSI) from a given location, etc.) A first set of ML models may use rules to model a pedestrian motion under specific circumstances and may have been used in various contexts (e.g. conditions of evacuation, etc.) A second set of ML models or algorithms (e.g., a Long Short-Term Memory (LSTM), a Convolutional Neural Network (CNN), etc.) may be used to learn trajectory/patterns. Such an approach may be more efficient when strong patterns may exist, for example, in universities when a massive number of students move every hour to other classes. Learning such patterns may allow for improvement of a time to associate to a new AP because of the predictions of the next AP while first user device 172 may move. Upon detecting that first user device 172 may be moving (based on an input from a location tracking system), the TPM may start active prediction on first user device's 172 trajectory and may simulate the most probable AP or the next AP that may be selected by first user device 172 on the predicted trajectory. The most probable AP may be predicted using the ML model.

If a probability for first user device 172 to move from first AP 122 to the next AP within a predetermined time (a parameter provided by the ML model) exceeds a first threshold with a predetermined confidence interval, the TPM may send a message to controller 110 to trigger pre-provisioning of resources as at second FE 245 as described below. For example, the TPM may predict roam time when first user device 172 is most likely to roam to the next AP, determine a time duration needed for pre-provisioning of resources at second FE 245 to create the secondary route; and trigger pre-provisioning of resources at second FE 245 to create the secondary route when the roam time is greater than the time duration.

A feedback loop may be used to tune the ML models and decision criterion used by the TPM. The feedback loop may be used to provide feedback on whether the next AP was correctly predicted. If the prediction accuracy is sufficiently high, the decision criterion may be tuned accordingly. If the predictions exceed a first given value, a more aggressive approach using a lower threshold for the confidence of the prediction may be adopted. Conversely if the prediction accuracy is below a second given value (that is, too low), the TPM may trigger an event only if the prediction confidence may be above a given value (that is, high). The first given value and the second given values may be provided by an administrator.

In another implementation, the TPM may predict more than one AP as the next AP where first user device 172 may be most likely to roam to. In this implementation, first AP 122 may trigger pre-provisioning resources on a set of FEs where first user device 172 may be most likely to roam to. A Recurrent Neural Network (RNN) model may be used to predict a longer trajectory where an outcome may be a set of visited APs and not just the next one. The TPM may then provide a list of visited APs, for example, next visited AP may be second AP 124 with a first probability value, next-next visited APs may be third AP 126 and fourth AP 128 with third and fourth probabilities respectively, etc. Each probability may be used by the TPM to decide whether or not to trigger a pre-provisioning event at those APs.

In yet another implementation, the TPM may even be trained to predict the exact time a roam time at which the next AP may be visited by first user device 172. Depending on a time duration required to pre-provision resources at the next AP and the roam time to the next AP, the TPM may decide to trigger pre-provisioning of resources at the next FE. For example, the TPM may trigger the pre-provisioning if the time duration to pre-provision resources is lower than the roam time. In another implementation, the next AP may directly be predicted without predicting first user device's 172. The TPM may run a simulation to determine the most likely AP by learning patterns of selected AP by first user devices.

Once the next AP where first user device 172 is mostly likely to roam to is predicted, controller 110 may pre-program fabric-based network 105 before first user device 172 may actually move to the next AP. For example, a new overlay route (BGP or LISP) may come as a secondary route. A primary route may remain as long as first user device 172 does not switch or fully converge to the next AP. As discussed above, there may be more than one secondary route if multiple APs are predicted to be next APs. Upon first user device 172 switching to the next AP there may be two options. In a first option, the primary route may be removed and the (or one of the) secondary routes may become primary. This first option may carry some latency saving but may still depend on a speed of the removal signal. An alternatively, or in parallel, any FE that may be forwarding data traffic to first user device 172 and got more than one route may replicate traffic and send it to all routes. Before first user device 172 moves, traffic sent over the secondary route may be black holed on an egress FE. After first user device 172 moves, it is the traffic sent to the primary route that may be black holed. As soon as the removal signal is received, the secondary route may replace the primary route.

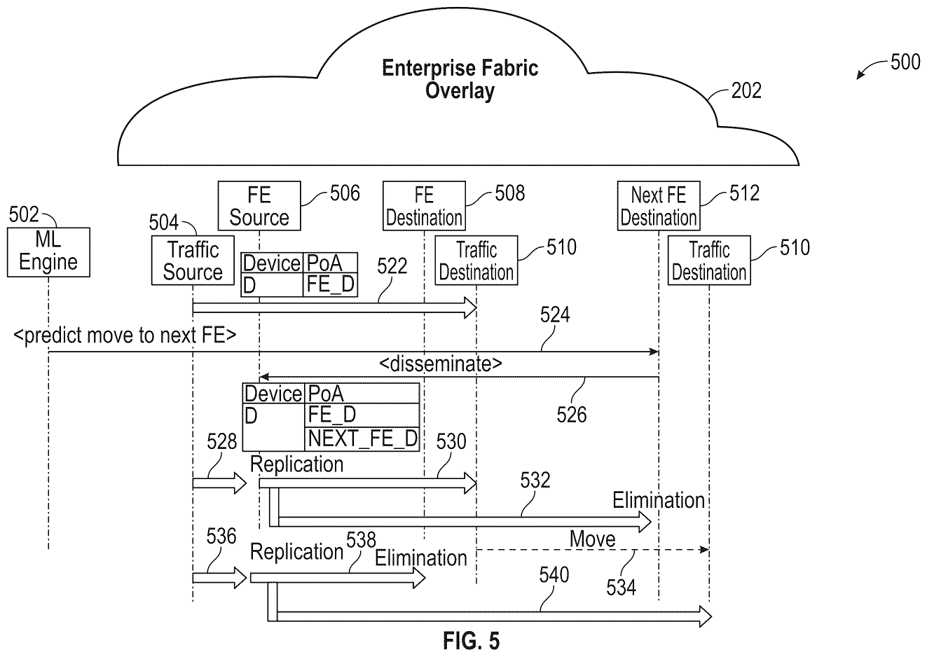

FIG. 5 illustrates replication/elimination process 500 during a user device roaming. As shown in FIG. 5, process 500 may be performed by ML engine 502, a traffic source 504, a FE source 506, a FE destination 508, a traffic destination 510, and a next FE destination 512. In examples, traffic source 504 may be first server 302, FE source 506 may be first FE 240, FE destination 508 may be third FE 250, traffic destination 510 may be first user device 172, and next FE destination 512 may be second FE 245.

As shown in FIG. 5, traffic source 504 may be sending data packets to traffic destination 510 through FE source 506 and FE destination 508 (stage 522). Traffic destination 510 may be connect to FE destination 508. ML engine 502 may predict that traffic destination 510 may roam from FE destination 508 to next FE destination 512 (stage 524). ML engine 502 may predict next FE destination 512 based on a current location of traffic destination 510, a trajectory of movement of traffic destination 510, and other historical data regarding a trajectory of movement of traffic destination 510 and other traffic destinations in enterprise fabric overlay 202.

Next FE destination 512 may inform its identity or address to FE source 506 (stage 526). After learning of Next FE destination's 512 identity, FE source 506 may receive data packets from traffic source 504 (stage 528). FE source 506 then may replicate the received data packets and send one set of received data packets to traffic destination 510 through FE destination 508 (stage 530) and the other set of received data packets to next FE destination 512 (stage 532). As discussed above the other set of received data packets sent to next FE destination 512 may be black holed at next FE destination 512 until traffic destination 510 has roamed to next FE destination 512.

Traffic destination 510 may roam to move to next FE destination 512 (stage 534). After traffic destination 510 has roamed to next FE destination 512, FE source 506 may receive next data packets from traffic source 504 (stage 536). FE source 506 then may replicate the received next data packets and send one set of received next data packets to FE destination 508 (stage 538) and the other set of received next data packets to next FE destination 512 (stage 532) to be sent to traffic destination 510. As discussed above the one set of received next data packets sent to FE destination 512 may be black holed at FE destination 508 as traffic destination may have now roamed to next FE destination 512.

FIG. 6 shows computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for a cross-domain approach to optimize WiFi device roaming in fabric-based network 105 as described above with respect to FIGS. 3-5. Computing device 600, for example, may provide an operating environment for controller 110, first AP 122, second AP 124, third AP 126, fourth AP 128, first access switch 132, second access switch 134, third access switch 136, fourth access switch 138, fifth access switch 140, sixth access switch 142, first distribution switch 152, second distribution switch 154, third distribution switch 156, fourth distribution switch 158, first core switch 162, second core switch 164, first border node 166, second border node 168, ML engine 502, traffic source 504, FE source 506, FE destination 508, traffic destination 510, or next FE destination 512. Controller 110, first AP 122, second AP 124, third AP 126, fourth AP 128, first access switch 132, second access switch 134, third access switch 136, fourth access switch 138, fifth access switch 140, sixth access switch 142, first distribution switch 152, second distribution switch 154, third distribution switch 156, fourth distribution switch 158, first core switch 162, second core switch 164, first border node 166, second border node 168, ML engine 502, traffic source 504, FE source 506, FE destination 508, traffic destination 510, and next FE destination 512 may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 600 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
determining, by a first Access Point (AP) attached to a first Fabric Edge (FE) of a fabric-based network, a current location of a first user device, wherein the first user device is wirelessly connected to the first AP;
receiving, by the first AP, an indication of movement of the first user device from the current location;
predicting, by the first AP, a next AP where the first user device is most likely to roam to from the first AP based on the current location and a trajectory of the movement from the current location, wherein the next AP is attached to a second FE of the fabric-based network; and
triggering, by the first AP, pre-provisioning of resources at the second FE to create a secondary route for the first user device through the second FE in the fabric-based network.

2. The method of claim 1, wherein triggering pre-provisioning of resources at the second FE to create the secondary route for the first user device through the second FE comprises:
predicting, by the first AP, a roam time when the first user device is most likely to roam to the next AP;
determining, by the first AP, a time duration needed for pre-provisioning of resources at the second FE to create the secondary route; and
triggering, by the first AP, pre-provisioning of resources at the second FE to create the secondary route when the roam time is greater than the time duration.

3. The method of claim 1, further comprising:
predicting, by the first AP, a third AP where the first user device is most likely to roam to from the next AP based on the current location and the trajectory of the movement from the current location; and
triggering, by the first AP, pre-provisioning of resources at a third FE associated with the third AP along with the second FE to create the secondary route for the first user device from each of the second FE and the third FE.

4. The method of claim 1, further comprising:
predicting, by the first AP, the next AP where the user device is most likely to roam to from the first AP further based on a location information of APs of the fabric-based network.

5. The method of claim 1, further comprising:
receiving, by the first AP, one set of replicated data packets from the first FE to be forwarded to the first user device, wherein data packets to be forwarded to the first user device are replicated at a source FE, wherein other set of replicated data packets are received at the second FE, and wherein the other set of replicated data packets are black holed at the second FE until roaming of the first user device is converged at the second FE.

6. The method of claim 5, further comprising:
receiving an indication that the first user device as roamed to the next AP; and
receiving, by the next AP, the other set of replicated data packets, wherein the one set of data packets are black holed at the first FE until roaming of the first user device is converged at the second FE.

7. The method of claim 1, wherein triggering pre-provisioning of resources at the second FE to create the secondary route comprises triggering formation of a Virtual extensible Local Area Network (VxLAN) tunnel from the second FE to a traffic source.

8. A system comprising:
a memory storage; and
a processing unit coupled to the memory storage, wherein the processing unit is operative to:
determine a current location of a first user device, wherein the first user device is wirelessly connected to a first AP, wherein the first AP is attached to a first Fabric Edge (FE) of a fabric-based network;
receive an indication of movement of the first user device from the current location;
predict a next AP where the first user device is most likely to roam to from the first AP based on the current location and a trajectory of the movement from the current location, wherein the next AP is attached to a second FE of the fabric-based network; and
trigger pre-provisioning of resources at the second FE to create a secondary route for the first user device through the second FE in the fabric-based network.

9. The system of claim 8, wherein the processing unit being operative to trigger pre-provisioning of resources at the second FE comprises the processing unit being operative to:
predict a roam time when the first user device is most likely to roam to the next AP;
determine a time duration needed for pre-provisioning of resources at the second FE to create the secondary route; and
trigger pre-provisioning of resources at the second FE when the roam time is greater than the time duration.

10. The system of claim 8, wherein the processing unit is further operative to:
predict a third AP where the first user device is most likely to roam to from the next AP based on the current location and the trajectory of the movement from the current location; and
trigger pre-provisioning of resources at a third FE associated with the third AP along with the second FE to create the secondary route for the first user device from each of the second FE and the third FE.

11. The system of claim 8, wherein the processing unit is further operative to:
predict the next AP where the user device is most likely to roam to from the first AP further based on a location information of APs of the fabric-based network.

12. The system of claim 8, wherein data packets to be forwarded to the first user device are replicated at a source FE, wherein a one set of replicated data packets are received by the first AP from the first FE to be forwarded to the first user device, wherein other set of replicated data packets are received at the second FE, and wherein the other set of replicated data packets are black holed at the second FE until roaming of the first user device is converged at the second FE.

13. The system of claim 12, wherein the other set of replicated data packets received by the second FE are sent to the first user device when the first user device has roamed to the next AP, and wherein the one set of data packets are black holed at the first FE until roaming of the first user device is converged at the second FE.

14. The system of claim 8, wherein the processing unit being operative to trigger pre-provisioning of resources at the second FE to create the secondary route comprises the processing unit being operative to trigger formation of a Virtual extensible Local Area Network (VxLAN) tunnel from the second FE to a traffic source.

15. A non-transitory computer-readable medium that stores a set of instructions which when executed perform a method comprising:
determining a current location of a first user device, wherein the first user device is wirelessly connected to a first Access Point (AP), wherein the first AP is attached to a first Fabric Edge (FE) of a fabric-based network;
receiving an indication of movement of the first user device from the current location;
predicting a next AP where the first user device is most likely to roam to from the first AP based on the current location and a trajectory of the movement from the current location, wherein the next AP is attached to a second FE of the fabric-based network; and
triggering pre-provisioning of resources at the second FE to create a secondary route for the first user device through the second in the fabric-based network.

16. The non-transitory computer-readable medium of claim 15, wherein triggering pre-provisioning of resources at the second FE to create the secondary route for the first user device through the second FE comprises:
predicting a roam time when the first user device is most likely to roam to the next AP;
determining a time duration needed for pre-provisioning of resources at the second FE to create the secondary route; and
triggering pre-provisioning of resources at the second FE to create the secondary route when the roam time is greater than the time duration.

17. The non-transitory computer-readable medium of claim 15, further comprising:
predicting a third AP where the first user device is most likely to roam to from the next AP based on the current location and the trajectory of the movement from the current location; and
triggering pre-provisioning of resources at a third FE associated with the third AP along with the second FE to create the secondary route for the first user device from each of the second FE and the third FE.

18. The non-transitory computer-readable medium of claim 15, further comprising:
predicting the next AP where the first user device is most likely to roam to from the first AP further based on a location information of APs of the fabric-based network.

19. The non-transitory computer-readable medium of claim 15, further comprising:
receiving one set of replicated data packets by the first AP from the first FE to be forwarded to the first user device, wherein data packets to be forwarded to the first user device are replicated at a source FE, wherein other set of replicated data packets are received at the second FE, and wherein the other set of replicated data packets are black holed at the second FE until roaming of the first user device is converged at the second FE.

20. The non-transitory computer-readable medium of claim 15, wherein triggering pre-provisioning of resources at the second FE to create the secondary route comprises triggering formation of a Virtual extensible Local Area Network (VxLAN) tunnel from the second FE to a third FE associated with a traffic source.
